(19) United States
(12) Patent Application Publication
(10) Pub. No.: US 2026/0079246 A1
(43) Pub. Date: Mar. 19, 2026

(54) LOCALIZATION DEVICE BETWEEN A USER AND AN AUTONOMOUS VEHICLE

(71) Applicant: STMicroelectronics International N.V., Geneva (CH)

(72) Inventors: Ghiath AL-KADI, Graz (AT); Rene WUTTE, Sankt Bartholoma (AT)

(73) Assignee: STMicroelectronics International N.V., Geneva (CH)

(21) Appl. No.: 19/319,978

(22) Filed: Sep. 5, 2025

(30) Foreign Application Priority Data
Sep. 16, 2024 (EP) 24200612.0
Nov. 18, 2024 (FR) FR2412573

(51) Int. Cl. G01S 13/08; G01S 13/02; G01S 13/46; H04W 4/029; H04W 4/40; H04W 4/80; H04W 12/0471

(52) U.S. Cl. CPC G01S 13/08; G01S 13/0209; G01S 13/46; H04W 4/029; H04W 4/40; H04W 4/80; H04W 12/0471; G01S 2013/468

(57) ABSTRACT

A localization device provides localization between a user and an autonomous vehicle. The device is embedded in user equipment or in the autonomous vehicle. An electronic circuit of the device exchanges RF signals with another localization device embedded in the autonomous vehicle or in the user equipment respectively. A measurement of at least a distance, by direct means like time of flight or indirect means, is made between the user equipment and the autonomous vehicle using the RF signals exchanges. The localizing of the autonomous vehicle or the user equipment, respectively, is made using the measured distance.

### PRIORITY CLAIM

This application claims the priority benefit of European Application for Patent No. EP24200612.0, filed Sep. 16, 2024, and French Application for Patent No. FR2412573, filed on Nov. 18, 2024, the contents of which are hereby incorporated by reference in their entireties to the maximum extent allowable by law.

### TECHNICAL FIELD

The present disclosure relates generally to the field of autonomous vehicles (for example, autonomous cars).

### BACKGROUND

Currently, when an autonomous car has to find a user, or a driver or a customer, the localization of the user is based on GPS signals. However, the accuracy of such localization is weak, especially in cases where no GPS connection or only a weak GPS connection is available (examples of which include a pickup of a user in subterranean or covered areas like airports, shopping malls and urban canyon).

Moreover, once the autonomous car is close to the user, it needs to alert the user, such as through a display or a sound generated on the vehicle and/or a notification on the user device, to guide the user to the car. The user needs to go to a pick-up area and find the right car. This solution is poorly adapted to crowded areas with multiple users, and leads to privacy issues and an unsatisfactory user experience.

Safety issues can also arise. For example, without enough precision, the car could stop at the other side of the street and the user is thus tempted to cross the street. This results in a potentially hazardous situation, or the user is just not able to reach the vehicle at all.

There is a need to addresses all or some of the drawbacks of known solutions.

### SUMMARY

One embodiment proposes a localization device providing localization between a user and an autonomous vehicle, configured to be embedded in user equipment or in the autonomous vehicle, and comprising an electronic circuit exchanging radio frequency (RF) signals with another localization device embedded in the autonomous vehicle or in the user equipment respectively, measuring at least a distance, by direct means like time of flight or indirect means, between the user equipment and the autonomous vehicle using the exchanged RF signals, and localizing the autonomous vehicle or the user equipment respectively using the measured distance.

According to a particular embodiment, the electronic circuit comprises a ultra-wide band (UWB) transceiver and the electronic circuit measures the distance between the user equipment and the autonomous vehicle using at least UWB signal exchanges.

According to a particular embodiment, the electronic circuit comprises at least two Rx antennas to measure an angle of arrival (A-o-A).

According to a particular embodiment, the UWB transceiver is configured to emit and receive UWB signals according to the IEEE 802.15.4ab standard.

According to a particular embodiment, the electronic circuit comprises at least one of a Bluetooth transceiver and a Wifi transceiver (i.e., a Bluetooth transceiver and/or a Wifi transceiver), and the electronic circuit measures the distance between the user equipment and the autonomous vehicle using at least one of Bluetooth signal exchanges and Wifi signal exchanges (i.e., using Bluetooth signal exchanges and/or Wifi signal exchanges).

According to a particular embodiment, the localization device further comprises a GPS receiver, and the electronic circuit localizes the autonomous vehicle or the user equipment using the measured distance and a GPS localization.

According to a particular embodiment, the electronic circuit further comprises a Narrowband transceiver, and wherein the electronic circuit measures the distance between the autonomous vehicle and the user equipment using Narrowband signal exchanges.

According to a particular embodiment, the localization device further comprises at least one inertial sensor, and the electronic circuit is configured to calculate additional information like an angle between a line, which connects the position of the user and the position of the autonomous vehicle, and a user direction when the localization device is embedded in the user equipment, or between said line and an autonomous vehicle's direction when the localization device is embedded in the autonomous vehicle, using at least one inertial sensor measurement, and localizes the autonomous vehicle or the user equipment respectively, also using the calculated angle.

According to a particular embodiment, the localization device further comprises an inertial measurement unit (IMU) including said at least one inertial sensor.

According to a particular embodiment, the electronic circuit receives a security key prior to RF signal exchanges and then exchanges RF signals using the security key.

Another embodiment discloses an autonomous vehicle comprising a localization device according to a particular embodiment.

According to a particular embodiment, the autonomous vehicle corresponds to a car or a drone or similar.

Another embodiment discloses a user equipment, or user device, comprising a localization device according to a particular embodiment.

According to a particular embodiment, the user equipment corresponds to a smartphone, a watch or a tablet.

Another embodiment discloses a system to manage exchanges between a user comprising an equipment and an autonomous vehicle each including a localization device according to a particular embodiment, which sends the security key to the localization device of the user equipment and to the localization device of the autonomous vehicle.

According to a particular embodiment, the system implements the following steps: creating a session between the user equipment and the autonomous vehicle; generating the security key; sending of the security key to the user equipment and to the autonomous vehicle; and sending an invalidation instruction of the security key to the autonomous vehicle at the end of the session between the user equipment and the autonomous vehicle.

According to a particular embodiment, the system also sends the security key to another user equipment.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates a first example of a use of localization devices according to a particular embodiment in user equipment and in an autonomous vehicle, compared to an autonomous vehicle which localizes a user using only GPS signals;

FIG. 2 illustrates a second example of a use of localization devices according to a particular embodiment in user equipment and in an autonomous vehicle;

FIG. 3 illustrates a process implemented in a system to manage exchanges between user equipment and an autonomous vehicle each including a localization device according to a particular embodiment;

FIG. 4 illustrates the differences between 802.15.4z (data & Ranging frames on UWB) and 802.15.4ab (data frames on narrowband and Ranging on UWB) IEEE standards ranging;

FIG. 5 illustrates a narrowband assisted MMS ranging which can be used during the exchanges between user equipment and an autonomous vehicle each including a localization device according to a particular embodiment;

FIG. 6 illustrates an autonomous vehicle and user equipment exchanging RF signals one to the other, and a system to manage these exchanges;

FIG. 7 illustrates a top-level example of a flow starting signing up to a service until the car arrives at customer;

FIG. 8 illustrates an example of signal exchanges carried out during a three message DS-TWR method implemented to obtain a distance between an autonomous vehicle and a user equipment; and

FIG. 9 illustrates examples of signals exchanges implemented according to a three message DS-TWR method between and initiator and several responders.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

An embodiment proposes using RF distance measurements in a vehicle equipped with radio frequency (RF) technology (comprising, for example, UWB (Ultra Wide Band) and more particularly RF signals according to the IEEE 802.15.4ab standard) to locate the position of users, or customers or drivers (hereafter referred to as “users” or “the user”), by distance bounding with mobile devices of the users. Therefore, the vehicle can pinpoint the position of the user pick-up location with a very high accuracy and stop close to the user.

Additionally, the user can see very accurately the position of the vehicle in the case that the vehicle is not permitted or able to get within close proximity of the user, and the system will guide the user to the parking spot of the vehicle.

An embodiment proposes binding a user device (such as a smartphone) with a vehicle to exchange at least one secure key provided by the cloud (or similar) to be used for secure ranging. In addition, the Inertial Measurement Unit (IMU) of the user equipment or of the autonomous vehicle can additionally be exchanged to provide improved guidance. The final ranging can be triggered based on the exchanged GPS location.

According to some embodiments, there is an exchange of position data via distance measurements between the autonomous vehicle and the user over the last distance (from basically Zero up to 20˜100 m is possible). One or several RF signal exchanges can be used to measure the distance between the user equipment 2000 and the autonomous vehicle 1000 (using, for example, a measurement of the time of flight of the signals between the user equipment 2000 and the autonomous vehicle 1000).

For example, the technique which is carried out for measuring the distance between the user equipment 2000 and the autonomous vehicle 1000 may correspond to Double-sided two-way ranging (DS-TWR), or three message DS-TWR. In this case, the user equipment 2000 sends a configuration to the autonomous vehicle 1000 and then a “ping” signal to anchors of the vehicle 1000, i.e., communication elements with, e.g., a predefined position in the vehicle 1000. After that all or at least one of the anchors responded back to the equipment 2000 with a “pong” signal, the equipment 2000 is sending an additional “ping” signal and after this the final data. The distance between the user equipment 2000 and the autonomous vehicle 1000 can be measured based on calculated runtimes of these exchanges.

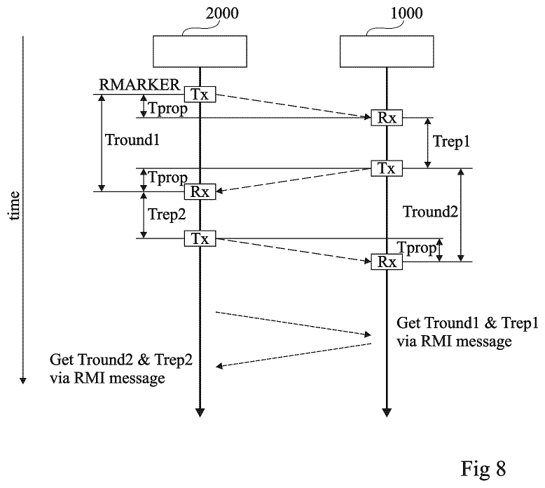

FIG. 8 schematically represents an example of a three message DS-TWR implemented between the user equipment 2000 and the autonomous vehicle 1000. In this configuration, the propagation time Tprop, i.e., the time of flight (ToF) between the equipment 2000 and the vehicle 1000, may be equal to:

$$Tprop = \frac{Tround 1 * Tround 2 - Trep 1 * Trep 2}{Tround 1 + Tround 2 + Trep 1 + Trep 2}$$

with Tround1 being the time between the emission of a first signal by the equipment 2000 to the vehicle 1000 and the reception by the equipment 2000 of second signal emitted by the vehicle 1000;
with Tround2 being the time between the emission of the second signal by the vehicle 1000 to the equipment 2000 and the reception by the vehicle 1000 of a third signal emitted by the equipment 2000;
with Trep1 being the time between the reception of the second signal by the vehicle 1000 and the emission of the third signal by the vehicle 1000; and
with Trep2 being the time between the reception of the second signal by the equipment 2000 and the emission of the third signal by the equipment 2000.

The distance between the user equipment 2000 and the autonomous vehicle 1000 can be calculated such that:

$$Distance = speed of light * Tprop$$

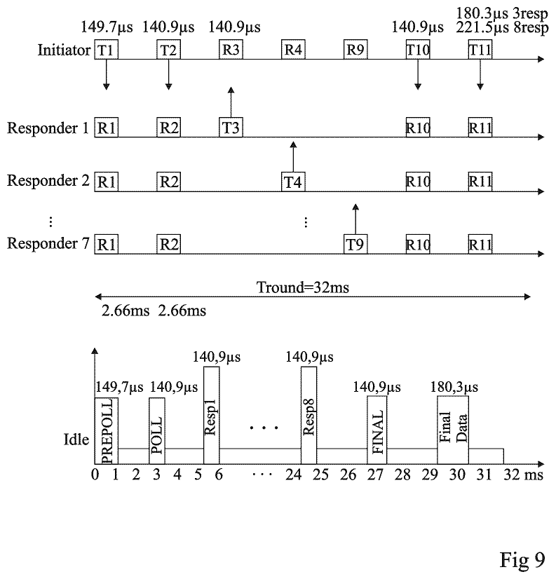

FIG. 9 shows examples of signals exchanges implemented according to a three message DS-TWR method between an initiator (e.g., the user equipment 2000) and several responders (e.g., anchors of the autonomous vehicle 1000). The values of the durations indicated on this figure are examples and can be different.

The calculations which are carried out include mainly the distance measured between vehicle and user but also an angle of arrival (A-o-A), IMU data like the direction faced or also a position on a map for the user, while the vehicle will use this data for similar reasons.

Alternatively, but most likely with less but good enough precision, other RF technologies could be used to do distance measurement. For example, Bluetooth Low Energy (BLE) channel sounding or WIFI direct could be used as an example.

It is thus disclosed a user localization with RF signals (such as UWB signals), by autonomous transport vehicle (such as autonomous cars), and also autonomous transport vehicle localization with RF signals by a user.

The previously disclosed solution proposes using an RF signal (such as UWB signals and particularly using the IEEE 802.15.4ab standard) to overcome current limitations of autonomous vehicles finding the user.

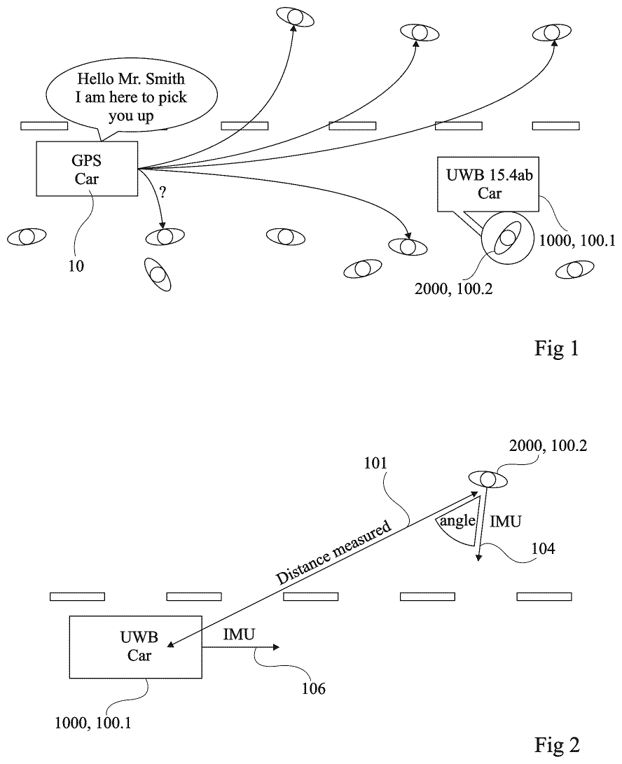

FIG. 1 shows a first example of a use of localization devices 100.1, 100.2 according to a particular embodiment in user equipment 2000 and in an autonomous vehicle 1000, compared to an autonomous vehicle 10 which localizes a user using only GPS signals.

In FIG. 1, an autonomous vehicle 10 (labelled “GPS Car”), which localizes a user using only GPS signals, is shown. Because this autonomous vehicle 10 uses only GPS signals, it is not able to localize accurately the user intended to use it. An announcement (e.g., visually or by sound) of the name, order ID or similar of the user is thus carried out by the autonomous vehicle 10. In FIG. 1, several arrows between the autonomous vehicle 10 and several potential users are drawn, illustrating that the autonomous vehicle 10 cannot localize accurately the user intended to use it, because all the persons designated by the arrows are located in an area in which the user intended to use the vehicle is located. In FIG. 1, a sound announcement labeled “Hello Mr. Smith. I am here to pick you up” is shown, indicating that currently an announcement in one way or the other is done.

In FIG. 1, another autonomous vehicle 1000 (labelled “UWB 15.4ab Car”) comprising a localization device 100.1 exchanging RF signals (e.g., an UWB signal) with another localization device 100.2 embedded in user equipment 2000 (e.g., a smartphone) is able to localize accurately the user intended to use it.

FIG. 2 illustrates a second example of a use of localization devices 100.1, 100.2 according to a particular embodiment in user equipment 2000 and in an autonomous vehicle 1000. Compared to the first example, the localization devices 100.1, 100.2 embedded in the user equipment 2000 and in the autonomous vehicle 1000 each comprise an inertial measurement unit (IMU) including at least one inertial sensor, not shown on FIG. 2. The electronic circuits of the localization devices 100.1, 100.2 calculate an angle (labeled “angle” on FIG. 2) between a line 101, which connects the position of the user and the position of the autonomous vehicle 1000, and a user direction 104 for the localization device 100.2, which is embedded in the user equipment 2000, or between said line 101 and an autonomous vehicle's direction 106 for the localization device 100.1, which is embedded in the autonomous vehicle 1000, using at least one measurement by an inertial sensor. Each of these localization devices 100.2, 100.1 localizes the autonomous vehicle 1000 or the user equipment 2000 respectively using the calculated angle and the RF signals exchanges.

For example, knowing the direction the vehicle 1000 is driving, and the customer is facing (data from the IMU) and information that distance is reducing (data from the distance measurement (e.g., via 802.15.4ab or BLE or wifi signals)), even without knowing the angle and direction (which could also be measured in case the user equipment 2000 have contact to three anchors of the vehicle 1000), it is possible to know from which side the vehicle 1000 is approaching the customer even if GPS is not available.

For example, in the configuration shown in FIG. 2, if the vehicle 1000 drives to the west and customer faces the north, the vehicle 1000 needs to approach right hand side. The same would be valid from the car point of view.

Thus, by use of additional exchanged information, like the IMU of the vehicle and that of the user device and the angle of arrival, guidance can be improved. For example, by knowing the direction and speed in which the vehicle is driving, and direction that the user is facing and information that the distance between the user device and the vehicle is decreasing, even without the angle, it is possible to know from which side the vehicle is approaching the user even if GPS is not available. As an example, the angle of arrival may be measured using at least two Rx antennas of each of the localization devices 100.1, 100.2. This measurement may be done by triangulation, based on obtained data. For example, knowing the distance between two anchors of the vehicle 1000 and the distance between each of the anchors and the user equipment 2000, it is possible to know the position of user equipment 2000. With a third anchor of the vehicle 1000, the flip of the user equipment 2000 can be excluded and it is possible to know also on which side of the car the user is.

In the above example, if the vehicle is driving towards the west and user is facing towards the north, the vehicle can approach the user on the right-hand side. The same is valid from the vehicle point of view.

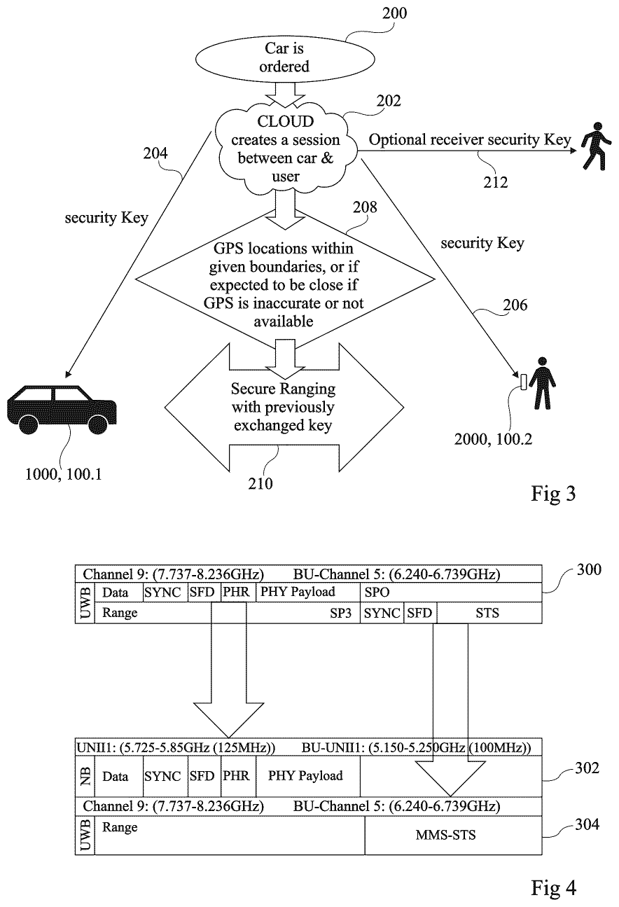

FIG. 3 illustrates a process implemented in a system to manage exchanges between a user comprising an equipment 2000 and an autonomous vehicle 1000 each including a localization device 100.2, 100.1 as previously disclosed. The process may include at least one of the following steps:
1) When the user orders a certain vehicle (step 200 on FIG. 3), the cloud (i.e., the management system) creates a session between the user device 2000 and the vehicle 1000 allocated to this user (step 202).
2) The session generates a security key, or encryption key, that is sent to the vehicle 1000 (sending designated by the number “204”) and the user device 2000 (sending designated by the number “206”) and is then used for secure ranging and potential data exchange between the vehicle 1000 and the user device 2000.

In the process shown in FIG. 3, before using the RF signal exchanges, GPS can be used as a trigger to start ranging and to determine a first coarse localization between the vehicle 1000 and the user device 2000 (step 208). GPS locations can be considered within given boundaries, or if expected to be close if GPS is inaccurate or not available.
3) When the vehicle 1000 is in close proximity to the user, an UWB session, or more generally RF signal exchanges, starts between the user device 2000 and the vehicle 1000 based on the exchanged key (step 210).
4) When the user is close enough to the vehicle 1000, the user is able to enter the vehicle 1000 and use it (driving actively or being driven) while the car, or vehicle, 1000 can also do secure inside/outside detection of the user device 2000 based on it.
4a) In case a different person is transported via the vehicle 1000, such as a robot taxi (e.g., a child), the ordering device can be used to verify and start the transport. Optionally, a second key can be generated for the device of the transported person. Such situation is shown on FIG. 3, wherein an optional receiver security key is sent to an ordering device (sending labeled “212”).
4b) In case an object is transported, the ordering device can be used to verify and start the transport.
5) When the user arrives at the destination (robot taxi) or decides to stop the driving session (e.g., car sharing) upon exiting the vehicle, the session is terminated, and the security key is invalidated.
5a) When the passenger is arriving at the destination, the user device ordering the ride is informed of arrival (via multiple means, e.g., could include a verification that passenger left at the right location) and the session and security key is terminated (optional on confirmation by device) optionally if the passenger device also receives a key, both keys are terminated.
5b) When the vehicle arrives at destination, secure ranging with user device of receiving user is started to allow unloading of the package. After the package is removed and delivery is done, the session and key are terminated on both devices.

The above process can be implemented in a system to manage exchanges between a user comprising an equipment and an autonomous vehicle each including a localization device as previously disclosed, which sends a security key (public or private) to the localization device of the user equipment and to the localization device of the autonomous vehicle.

The system can implement the following steps: creating a session between the user equipment and the autonomous vehicle; generating the security key; sending the security key to the user equipment and to the autonomous vehicle; and sending an invalidation instruction of the security key to the autonomous vehicle and user equipment at the end of the session between the user equipment and the autonomous vehicle.

FIG. 4 illustrates RF and Narrowband signals exchanged between user equipment 2000 and an autonomous vehicle 1000 each including a localization device.

The example shown in the upper part of FIG. 4 corresponds to a UWB signal according to IEEE 802.15.4z, which can be used for the RF signal exchanges between the user equipment 2000 and the autonomous vehicle 1000 each including a localization device 100.2, 100.1. The upper part of FIG. 4 shows an example of a UWB frame 300 exchanged between the user equipment 2000 and the autonomous vehicle 1000, for example on a channel 9 between 7,737 GHz and 8,236 GHz or a channel 5 between 6,240 GHZ and 6,739 GHz. Other channel(s) can be used for the RF signal exchanges.

To get the full potential, regarding the distance and the accuracy, of the localization devices, it is possible to use, as shown in the lower part of FIG. 4, a UWB signal according to IEEE 802.15.4ab because the link budget is increased up to 15˜17 dB, thus increasing the secure ranging distance by a factor of 4˜6× compared to the range obtained with a UWB signal according to IEEE 802.15.4z. This full potential can be obtained by using Multiple-millisecond (MMS) and Narrowband assisted ranging. The lower part of FIG. 4 shows an example of a UWB and Narrowband frames 302, 304 exchanged between the user equipment 2000 and the autonomous vehicle 1000, for example on a channel 9 between 7,737 GHz and 8,236 GHz or a channel 5 between 6,240 GHZ and 6,739 GHz for the UWB frames, and a UNII-3 band between 5,725 GHz and 5.85 GHz or a UNII-1 band between 5.15 GHz and 5.25 GHz. Other channels can be used for the RF signal exchanges.

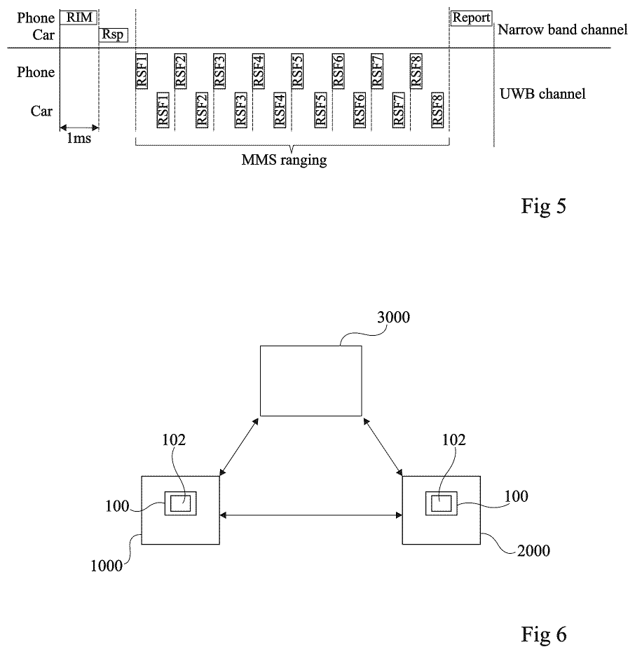

In the example shown in FIG. 5, data communication is exchanged at one Narrow-band channel, leading to approximately 17 dB increase vs. SP0. In this case, there is a a replacement of SP0 data frames with 250 channels available, synchronized clock for NB with UWB MMS ranging. Moreover, bi-directional data transfer allows additional optimizations during ranging session, e.g., changing MMS mode or measurement frequency.

In the example shown in FIG. 5, distance measurement with MMS ranging leads to approximately 15 dB increase vs. SP3 (17˜18 dB vs. SP0). Thus, SP3 frames are replaced.

In FIG. 5, the autonomous vehicle 1000 is labeled “Car” and the user equipment 2000 is labeled “Phone”.

FIG. 6 shows an autonomous vehicle 1000, e.g., an autonomous car, and user equipment 2000, e.g., a smartphone, exchanging RF signals one to the other, and a system 3000 to manage these exchanges.

Each of the vehicle 1000 and the equipment 2000 comprises a localization device 100 between a user and an autonomous vehicle, configured to be embedded in user equipment 2000 or in the autonomous vehicle 1000, and comprising an electronic circuit 102 exchanging RF signals with another localization device 100 embedded in the autonomous vehicle 1000 or in the user equipment 2000 respectively, measuring a distance between the user equipment 2000 and the autonomous vehicle 1000 using the RF signals exchanges, and localizing the autonomous vehicle 1000 or the user equipment 2000 respectively using the measured distance.

For example, the localization device 100.2 of the user equipment 2000 may correspond to an RF chipset capable of doing the ranging operation. This RF chipset may be configured to carry out UWB signals exchange with or without 802.15.4ab specification, BLE or Wifi. For example, the localization device 100.1 of the autonomous vehicle 1000 may correspond to an RF chipset inside an anchor of the vehicle and adjusted for a phone usage.

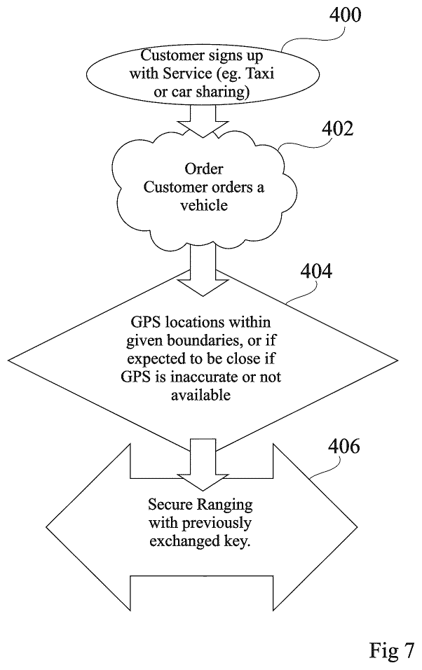

FIG. 7 illustrates an example of an establishment of secure ranging between the user equipment 2000 and the autonomous vehicle 1000.

First, a user, or customer, signs up with a service, thus forming a proof of person (step 400). This service may correspond to a taxi or car sharing.

Then, the user orders the vehicle 1000 (step 402). A secure key, or security key, is sent to the vehicle 1000 and user device 2000. This secure key could be similar to a friend key or digital key or end point key on phone and vehicle key on car.

In the process shown in FIG. 7, before using the RF signal exchanges, GPS can be used to determine a first coarse localization between the vehicle 1000 and the user device 2000 (step 404). GPS locations can be considered within given boundaries, or if expected to be close if GPS is inaccurate or not available.

Then, when the vehicle 1000 and user device 2000 are in proximity, temporal, or ephemeral, keys are generated if close by where the public keys are exchanged between car, i.e., the vehicle 1000, and the device 2000.

With this key pairs and after Diffie-Hellmann method for example, a key is generated by using multiplication methods with both keys.

From this the session keys & URSK (UWB ranging session key) are generated.

Additional keys can be derived for secure ranging (STS, MMS RFI, etc.).

The secure ranging with previously exchanged key is then carried out (step 406).

Other establishments of secure ranging between the user device and the car are possible.

For all the examples, when a user orders a certain autonomous vehicle, e.g., an autonomous car, the cloud can create a session between the user device and the vehicle allocated to this user. The session can generate a security key that is then used for secure ranging between the vehicle and the user. When the vehicle is in close proximity to the user, an UWB session, or RF signals session, starts between the user device and the vehicle.

A particular embodiment can lead to a better user experience. In particular, if rolled out and used by a lot of people, the pickup is much smoother, gives a better user experience, and is safer (vehicle approaches at the right side, people don't need to cross streets).

Wrong pickup of user may be prevented especially in crowded situations.

According to a particular embodiment, a capability of the standard IEEE 802.15.4ab may be used to do precise (˜10 cm) ranging on larger distances, even possible up to 100 m down to the last meter.

A particular embodiment proposes the use of RF signals, e.g., 15.4ab UWB technology (i.e. the standard IEEE 802.15.4ab), to allow vehicles and devices equipped with this technology to exchange distance, angle and other position/orientation related data to allow precise pickup of users by autonomous vehicles and in case the vehicle cannot approach the user to navigate the user to the vehicle.

For example, 15.4ab UWB signals will give precise and long range “position” (distance and angle) data and is not affected if area is covered like GPS. No need to call for the user as vehicle can identify the position precisely.

The previously described solution may apply to the fields of rental cars, robot taxis, delivery drones or car sharing. The previously described solution may enable to locate a user discreetly, safe and accurately. The previously described solution applies to any type of autonomous vehicle, e.g., for transporting human, animal, object, etc.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A localization device providing localization between a user and an autonomous vehicle, configured to be embedded in user equipment or in the autonomous vehicle, and comprising:
an electronic circuit configured to exchange radio frequency (RF) signals with another localization device embedded in the autonomous vehicle or in the user equipment, respectively, the electronic circuit configured to measure at least a distance, either directly using time of flight or indirectly, between the user equipment and the autonomous vehicle using the exchange of RF signals, and localize the autonomous vehicle or the user equipment, respectively, using the measured distance.

2. The localization device according to claim 2, further comprising at least two receive (Rx) antennas coupled to the electronic circuit, and wherein the electronic circuit is configured to measure an angle of arrival using triangulation based on data obtained through the at least two Rx antennas.

3. The localization device according to claim 1, wherein the electronic circuit comprises an ultra wide band (UWB) transceiver and wherein the electronic circuit measures the distance between the user equipment and the autonomous vehicle using at least UWB signal exchanges.

4. The localization device according to claim 3, wherein the UWB transceiver is configured to emit and receive UWB signals according to the IEEE 802.15.4ab standard.

5. The localization device according to claim 1, wherein the electronic circuit comprises at least one of a Bluetooth transceiver and a Wifi transceiver, and wherein the electronic circuit measures the distance between the user equipment and the autonomous vehicle using at least one of Bluetooth signal exchanges and Wifi signal exchanges.

6. The localization device according to claim 1, further comprising a GPS receiver configured to generate a GPS localization, and wherein the electronic circuit localizes the autonomous vehicle or the user equipment using the measured distance and the GPS localization.

7. The localization device according to claim 1, wherein the electronic circuit further comprises a Narrowband transceiver, and wherein the electronic circuit measures the distance between the autonomous vehicle and the user equipment using Narrowband signal exchanges.

8. The localization device according to claim 1, further comprising at least one inertial sensor, and wherein the electronic circuit is configured to calculate additional information like an angle between a line, which connects the position of the user and the position of the autonomous vehicle, and a user direction when the localization device is embedded in the user equipment, or between said line and an autonomous vehicle's direction when the localization device is embedded in the autonomous vehicle, using at least one inertial sensor measurement, and localizes the autonomous vehicle or the user equipment respectively, also using the calculated angle.

9. The localization device according to claim 8, further comprising an inertial measurement unit (IMU) including said at least one inertial sensor.

10. The localization device according to claim 1, wherein the electronic circuit receives a security key prior to RF signal exchanges and then exchanges RF signals using the security key.

11. The localization device according to claim 10, wherein the security key is invalidated at an end of a communications session.

12. An autonomous vehicle, comprising the localization device according to claim 1, wherein the autonomous vehicle comprises one of a car or a drone.

13. User equipment, comprising the localization device according to claim 1, wherein the user equipment comprises one of a smartphone, a watch or a tablet.

14. A system to manage exchanges between a user comprising an equipment and an autonomous vehicle each including the localization device according to claim 1, wherein the system is configured to send a security key to the localization device of the user equipment and to the localization device of the autonomous vehicle.

15. The system according to claim 14, configured to:
create a session between the user equipment and the autonomous vehicle;
generate the security key;
send the security key to the user equipment and to the autonomous vehicle;
send an invalidation instruction of the security key to the autonomous vehicle at the end of the session between the user equipment and the autonomous vehicle.

16. The system according to claim 14, further configured to send the security key to another user equipment.
